(19) United States
(12) Patent Application Publication
(10) Pub. No.: US 2025/0125470 A1
(43) Pub. Date: Apr. 17, 2025

(54) THERMAL BARRIER FOAM SYSTEMS FOR TRACTION BATTERY ARRAYS

(71) Applicant: FORD GLOBAL TECHNOLOGIES, LLC, Dearborn, MI (US)

(72) Inventors: Sangyeon KIM, Northville, MI (US); Jie DENG, Novi, MI (US); Liam E. WEST, Ferndale, MI (US); Chulheung BAE, Troy, MI (US); Jeffrey Scott MAYVILLE, Ypsilanti, MI (US); Adam DENLINGER, Saline, MI (US)

(21) Appl. No.: 18/484,637

(22) Filed: Oct. 11, 2023

(51) Int. Cl. H01M 50/262; H01M 10/625; H01M 10/658; H01M 50/249; H01M 50/507

(52) U.S. Cl. CPC H01M 50/262; H01M 10/625; H01M 10/658; H01M 50/249; H01M 50/507; H01M 2220/20

(57) ABSTRACT

Battery arrays are provided for traction battery packs. An exemplary battery array may include a thermal barrier foam system that includes one or more foam blocks arranged to fill void spaces within the battery array to mitigate cell-to-cell and/or array-to-array thermal propagation. The foam blocks may be secured to hook structures of a bus bar module of the battery array. The hook structures can be integrated as part of the bus bar module or part of a separate structure that is attachable to the bus bar module.

### TECHNICAL FIELD

This disclosure relates generally to electrified vehicle traction battery packs, and more particularly to thermal barrier foam systems for mitigating thermal propagation within battery arrays of traction battery packs.

### BACKGROUND

Electrified vehicles include a traction battery pack for powering electric machines and other electrical loads of the vehicle. The traction battery pack includes a plurality of battery cells and various other battery internal components that support electric vehicle propulsion.

### SUMMARY

A battery array for a traction battery pack according to an exemplary aspect of the present disclosure includes, among other things, a bus bar module, a hook structure connected to the bus bar module, and a foam block attached to the hook structure.

In a further non-limiting embodiment of the foregoing battery array, the bus bar module is covered by a plate member of an array housing.

In a further non-limiting embodiment of either of the foregoing battery arrays, the hook structure is an integral subcomponent of a bus bar module frame of the bus bar module.

In a further non-limiting embodiment of any of the foregoing battery arrays, the hook structure includes a base hook and a secondary hook that protrudes outwardly from a side of the base hook.

In a further non-limiting embodiment of any of the foregoing battery arrays, the foam block is overmolded around the hook structure.

In a further non-limiting embodiment of any of the foregoing battery arrays, the hook structure is part of a support fixture that is clipped to the bus bar module.

In a further non-limiting embodiment of any of the foregoing battery arrays, the hook structure extends from a base of the support fixture.

In a further non-limiting embodiment of any of the foregoing battery arrays, the foam block is overmolded around the hook structure.

In a further non-limiting embodiment of any of the foregoing battery arrays, the hook structure includes a flexible clip that engages a clip structure of a bus bar module frame of the bus bar module as the support fixture is moved into engagement with the bus bar module frame.

In a further non-limiting embodiment of any of the foregoing battery arrays, the hook structure is disposed at a vertically upper section of a bus bar module frame of the bus bar module, and further comprising a second hook structure disposed at a vertically lower section of the bus bar module frame. A second foam block is attached to the second hook structure.

A battery array for a traction battery pack according to another exemplary aspect of the present disclosure includes, among other things, a cell stack, a bus bar module configured for electrically connecting a plurality of battery cells of the cell stack, a first foam block attached to a first hook structure of the bus bar module and positioned to fill a first space between the cell stack and the bus bar module, and a second foam block attached to a second hook structure of the bus bar module and positioned to fill a second space between the cell stack and the bus bar module.

In a further non-limiting embodiment of the foregoing battery array, the first hook structure is disposed at a vertically upper section of a bus bar module frame of the bus bar module, and the second hook structure is disposed at a vertically lower section of the bus bar module frame.

In a further non-limiting embodiment of either of the foregoing battery arrays, the first hook structure is an integral subcomponent the bus bar module frame, and the second hook structure is part of a support fixture that is clipped to the bus bar module frame.

In a further non-limiting embodiment of any of the foregoing battery arrays, the first hook structure includes a base hook and a secondary hook that protrudes outwardly from a side of the base hook.

In a further non-limiting embodiment of any of the foregoing battery arrays, the base hook includes a pair of hook legs that are at least partially separated by an indentation.

In a further non-limiting embodiment of any of the foregoing battery arrays, the secondary hook includes a design that mimics that of the base hook.

In a further non-limiting embodiment of any of the foregoing battery arrays, the first foam block is overmolded around the first hook structure.

In a further non-limiting embodiment of any of the foregoing battery arrays, the second hook structure extends from a base of the support fixture.

In a further non-limiting embodiment of any of the foregoing battery arrays, the second foam block is overmolded around the second hook structure.

In a further non-limiting embodiment of any of the foregoing battery arrays, the second hook structure includes a flexible clip that engages a clip structure of a bus bar module frame as the support fixture is moved into engagement with the bus bar module frame.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 illustrates a battery array of a traction battery pack.

FIG. 3 illustrates the battery array of FIG. 2 with portions of an array housing removed for better illustrating a cell stack and a pair of bus bar modules of the battery array.

FIG. 4 is a cross-sectional view through section 4-4 of FIG. 3.

FIG. 5 illustrates a bus bar module including a thermal barrier foam system.

FIG. 6 is an exploded view of select portions of the bus bar module of FIG. 5.

FIG. 7 illustrates a foam block of the thermal barrier foam system of FIG. 5.

FIG. 8 is a partial exploded view of a battery array.

FIG. 9 is a blown-up view of a portion of a thermal barrier foam system of the battery array of FIG. 8.

FIG. 10 is an exploded view of the thermal barrier foam system of FIGS. 8 and 9.

FIG. 11 illustrate the connection of a foam block to a bus bar module.

### DETAILED DESCRIPTION

This disclosure details battery arrays for traction battery packs. An exemplary battery array may include a thermal barrier foam system that includes one or more foam blocks arranged to fill void spaces within the battery array to mitigate cell-to-cell and/or array-to-array thermal propagation. The foam blocks may be secured to hook structures of a bus bar module of the battery array. The hook structures can be integrated as part of the bus bar module or part of a separate structure that is attachable to the bus bar module. These and other features are discussed in greater detail in the following paragraphs of this detailed description.

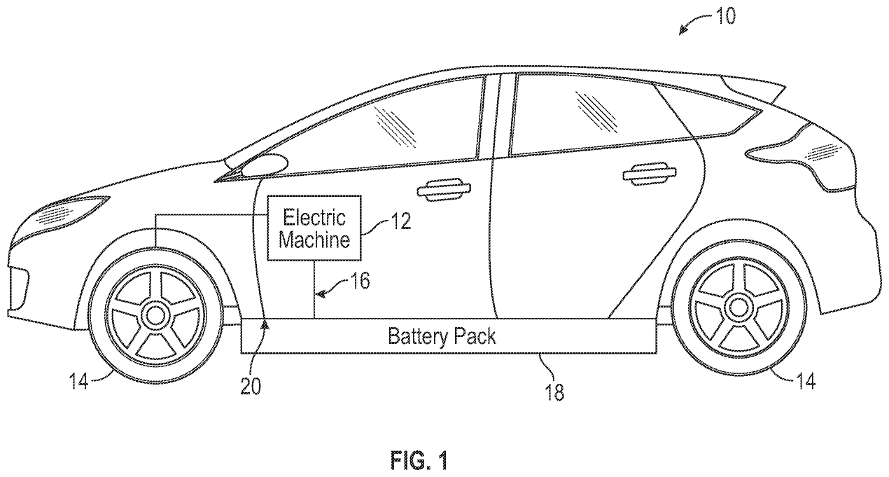

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In an embodiment, the electrified vehicle 10 is a full electric vehicle propelled solely through electric power, such as by one or more electric machines 12, without any assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cell groupings capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

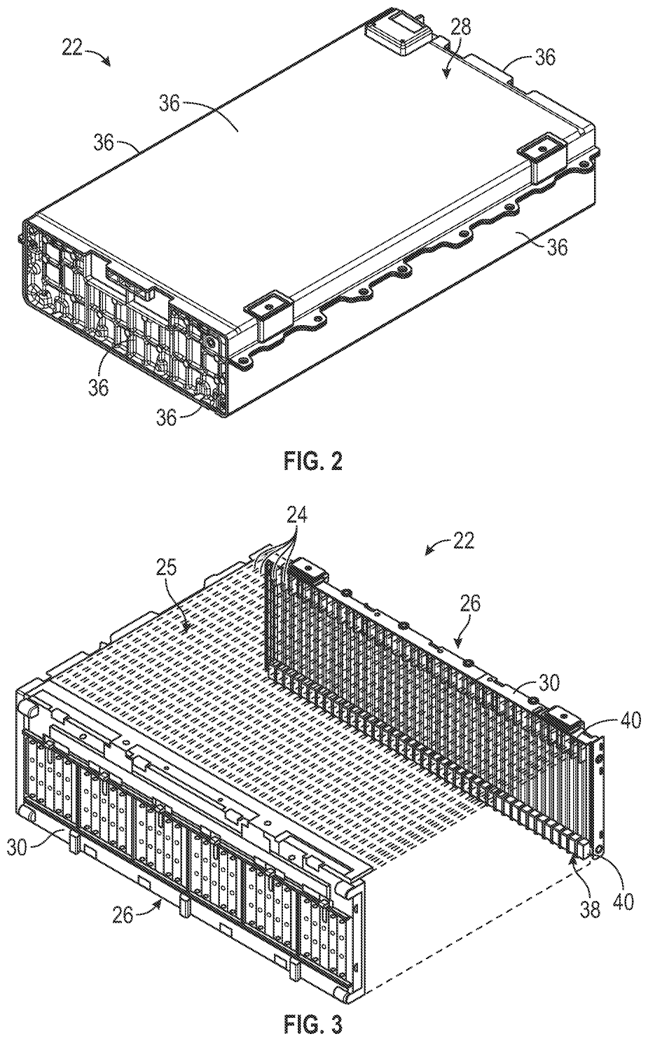

FIGS. 2, 3, and 4 illustrate an exemplary battery array 22 for a traction battery pack, such as the traction battery pack 18 of FIG. 1, for example. One or more battery arrays having a design similar to the battery array 22 shown in FIGS. 2-4 could be packaged within the traction battery pack 18. As explained in further detail below, the battery array 22 may incorporate thermal barrier features designed for limiting cell-to-cell and/or array-to-array thermal propagation during battery thermal events associated with the battery array 22. A battery thermal event may occur, for example, during over-charging conditions, over-discharging conditions, or other conditions.

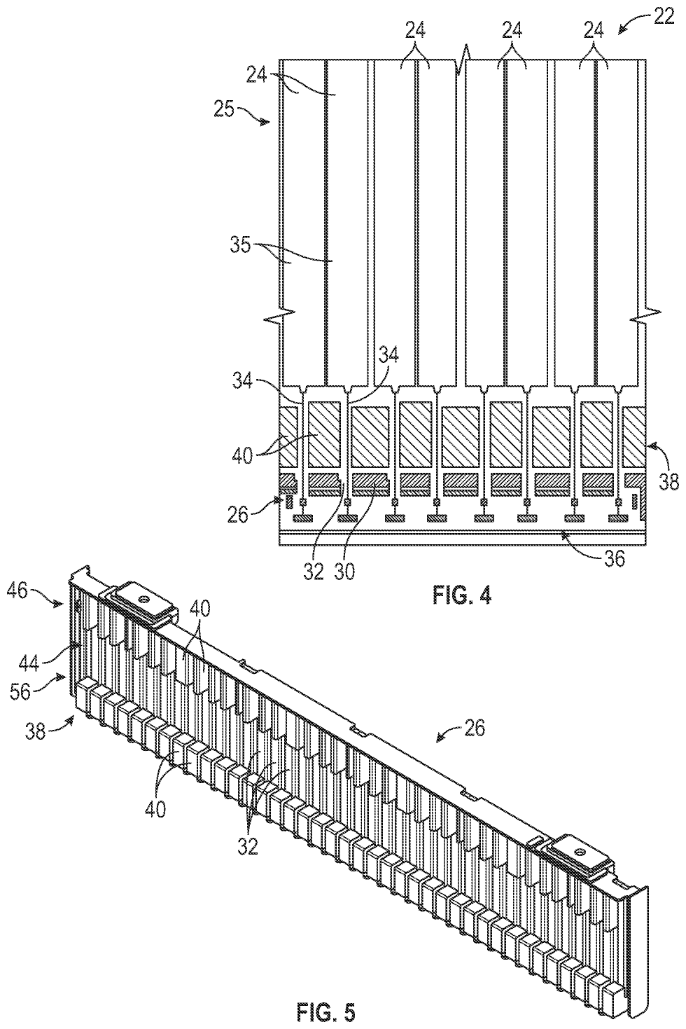

The battery array 22 may include a plurality of battery cells 24 (best seen in FIGS. 3 and 4). In an embodiment, the battery cells 24 are lithium-ion pouch cells. However, battery cells having other geometries (cylindrical, prismatic, etc.) and/or chemistries (nickel-metal hydride, lead-acid, etc.) could alternatively be utilized within the scope of this disclosure. The total number of battery cells 24 provided within the battery array 22 could vary and is thus not intended to limit this disclosure.

The battery cells 24 may be stacked side-by-side along a stack axis to construct a grouping of battery cells 24. The grouping of battery cells 24 may be referred to as a cell stack 25. The cell stack 25 may be subdivided into two or more cell banks, although the exact configuration of the cell stack 25 is not intended to limit this disclosure.

The cell stack 25 may be arranged to extend between a pair of bus bar modules 26 that are configured to electrically connect the battery cells 24 of the cell stack 25. One bus bar module 26 may be disposed along each longitudinal side of the cell stack 25, for example.

Each bus bar module 26 may include a plurality of bus bars (not shown) held within a bus bar module frame 30. The total number of bus bars held within each bus bar module frame 30 is not intended to limit this disclosure. The bus bars may be metallic components of the bus bar module 26, and the bus bar module frame 30 may be a plastic component of the bus bar module 26. In an embodiment, the bus bars are made of copper or aluminum, and the bus bar module frame 30 is made of polypropylene or polyethylene. However, other materials are contemplated within the scope of this disclosure.

The battery cells 24, the bus bar modules 26, and various outer internal components of the battery array 22 may be housed within an array housing 28 (best shown in FIG. 2). The array housing 28 may be arranged to substantially surround the cell stack 25 of battery cells 24, for example. The array housing 28 may include a plurality of plate members 36. In an embodiment, the plate members 36 may be arranged to provide a top cover, a bottom cover, a pair of side covers, and a pair of end covers of the battery array 22. However, other configurations of the array housing 28 are contemplated within the scope of this disclosure. Each bus bar module 26 may be positioned between the cell stack 25 and one of the plate members 36.

Referring now primarily to FIGS. 4 and 5, the bus bar module frame 30 of each bus bar module 26 may include a plurality of slots 32. Each slot 32 may be sized and shaped for receiving a cell tab terminal 34 (see FIG. 4) of one or more of the battery cells 24. Each cell tab terminal 34 may project outwardly from a housing 35 of its respective battery cell 24. The cell tab terminals 34 may extend through the slots 32 such that at least a portion of each cell tab terminal 34 is located on an opposite side of the bus bar module frame 30 from its respective battery cell 24. Neighboring cell tab terminals 34 may then be jointed together, such as by one or more bus bars, for electrically connecting the battery cells 24 of the battery array 22 to one another. Once electrically coupled, the battery cells 24 may supply electrical power necessary for achieving electric propulsion of the electrified vehicle 10.

The battery array 22 may additionally include a thermal barrier foam system 38 designed for mitigating thermal propagation and other effects of battery thermal events. The thermal barrier foam system 38 may include a plurality of foam blocks 40. The foam blocks 40 may be strategically positioned within void spaces found within the battery array 22 for mitigating the effects of battery thermal events. For example, among other benefits, the thermal barrier foam system 38 may be configured to mitigate cell-to-cell and/or array-to-array thermal propagation, increase thermal insulation between the battery cells 24 of the battery array 22, absorb heat, etc.

In an embodiment, the foam blocks 40 are positioned to fill void spaces extending between the cell stack 25 and each bus bar module 26. One or more of the foam blocks 40 may embody a different size and/or shape from the other foams blocks 40 of the thermal barrier foam system 38.

Each foam block 40 may be made of a silicone-based foam and may be pre-cast or over-molded into a desired size and shape. However, other foam materials or combinations of materials, including but not limited to polyurethane foam, could alternatively or additionally be utilized within the scope of this disclosure.

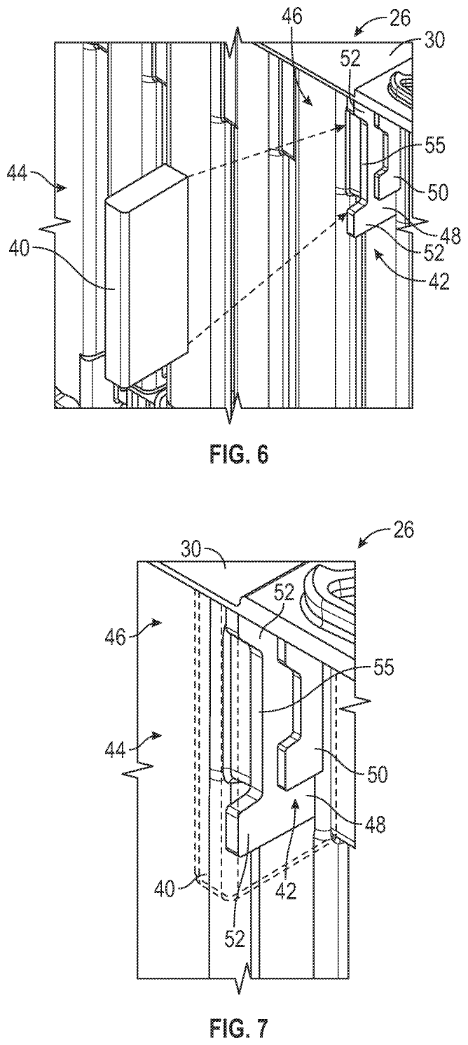

Referring now primarily to FIGS. 6 and 7, the bus bar module frame 30 of each bus bar module 26 may include a plurality of hook structures 42 adapted for attaching a first portion of the foam blocks 40 of the thermal barrier foam system 38 to the bus bar module frame 30. The hook structures 42 may be provided on an interior side 44 of the bus bar module frame 30. The interior side 44 may face in a direction toward the cell stack 25. The hook structures 42 may be disposed along a vertically upper section 46 of the bus bar module frame 30. Vertical and horizontal, for purposes of this disclosure, are with reference to ground in an ordinary orientation of the electrified vehicle 10 during operation.

In an embodiment, each hook structure 42 is an integral subcomponent of the bus bar module frame 30. For example, each hook structure 42 could be integrally molded as part of the bus bar module frame 30. In another embodiment, the hook structure 42 is a separate component that can be attached (e.g., welded, adhered, etc.) to the bus bar module frame 30.

Each hook structure 42 include a base hook 48 and at least one secondary hook 50 that protrudes outwardly from a side of the base hook 48 to provide a tiered design. The base hook 48 may include a pair of hook legs 52 that project outwardly in a direction away from the interior side 44 of the bus bar module frame 30. An indentation 55 may at least partially separate the hook legs 52 from one another. The secondary hook(s) 50 may include a design that mimics that of the base hook 48, albeit on a reduced scale.

One foam block 40 may be secured to each hook structure 42 of the bus bar module frame 30. In an embodiment, one foam block 40 is overmolded around each hook structure 42. However, other attachment methodologies are contemplated within the scope of this disclosure. The tiered design of the hook structure 42 may provide increased fixation strength between the foam blocks 40 and the bus bar module frame 30.

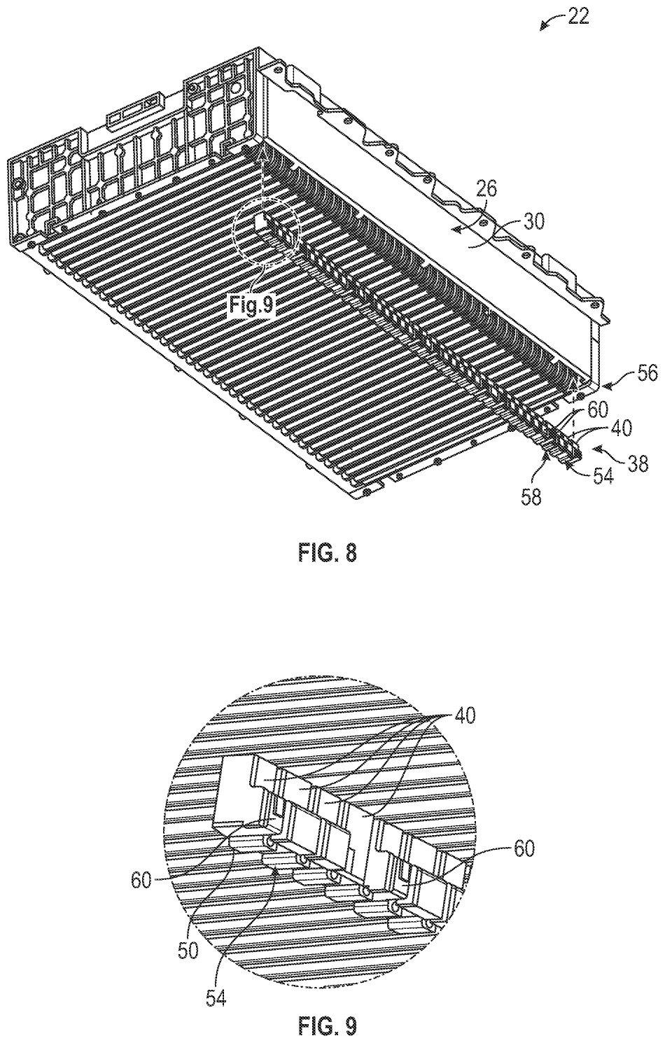

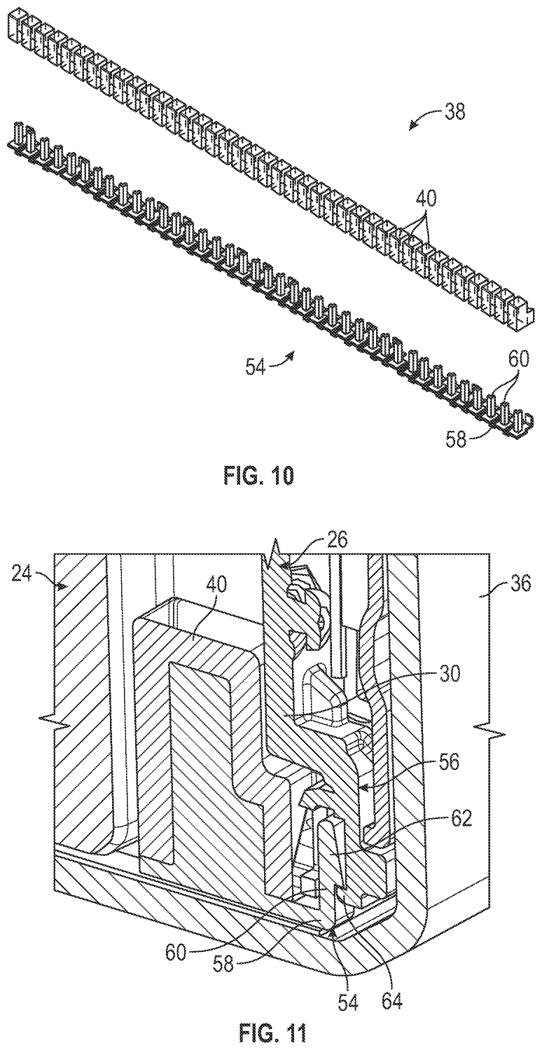

Referring now to primarily to FIGS. 8, 9, 10, and 11, a second portion of the foam blocks 40 of the thermal barrier foam system 38 may alternatively or additionally be attached to the bus bar module frame 30 by a support fixture 54. The support fixture 54 may be connected at a vertically lower section 56 of the bus bar module frame 30. The support fixture 54 may be made of a plastic material. However, other materials or combinations of materials are contemplated within the scope of this disclosure.

The support fixture 54 may include a base 58 and a plurality of hook structures 60 that project upwardly from the base 58. One foam block 40 may be secured to each hook structure 60 of the support fixture 54. In an embodiment, the foam blocks 40 are overmolded around the hook structures 60. However, other attachment methodologies are contemplated within the scope of this disclosure.

In an embodiment, the support fixture 54 may be clipped or snap-connected to the vertically lower section 56 of the bus bar module frame 30 in order to secure the foam blocks 40 relative to the bus bar module frame 30. For example, one or more of the hook structures 60 of the support fixture 54 may include a flexible clip 62 that is adapted to engage a corresponding clip structure 64 of the bus bar module frame 30 (see FIG. 11). The flexible clip 62 may engage the clip structure 64 as the support fixture 54 is moved into engagement with the bus bar module frame 30 to snap connect the support fixture 54, and thus the foam blocks 40, to the bus bar module frame 30. Once attached, the support fixture 54 may establish portions of the vertically lower section 56 of the bus bar module frame 30. An opposite configuration is also contemplated in which the clip of the bus bar module 26 flexes when the support fixture 54 is moved into engagement with the bus bar module 26.

The exemplary battery arrays of this disclosure include thermal barrier foam systems that are designed to mitigate the effects of battery thermal events within the battery array. The thermal barrier foam systems may provide numerous advantages over known solutions, including but not limited to presenting a novel configuration that significantly slows or even prevents cell-to-cell thermal propagation during battery thermal events.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A battery array for a traction battery pack, comprising:
a bus bar module;
a hook structure connected to the bus bar module; and
a foam block attached to the hook structure.

2. The battery array as recited in claim 1, wherein the bus bar module is covered by a plate member of an array housing.

3. The battery array as recited in claim 1, wherein the hook structure is an integral subcomponent of a bus bar module frame of the bus bar module.

4. The battery array as recited in claim 3, wherein the hook structure includes a base hook and a secondary hook that protrudes outwardly from a side of the base hook.

5. The battery array as recited in claim 4, wherein the foam block is overmolded around the hook structure.

6. The battery array as recited in claim 1, wherein the hook structure is part of a support fixture that is clipped to the bus bar module.

7. The battery array as recited in claim 6, wherein the hook structure extends from a base of the support fixture.

8. The battery array as recited in claim 7, wherein the foam block is overmolded around the hook structure.

9. The battery array as recited in claim 6, wherein the hook structure includes a flexible clip that engages a clip structure of a bus bar module frame of the bus bar module as the support fixture is moved into engagement with the bus bar module frame.

10. The battery array as recited in claim 1, wherein the hook structure is disposed at a vertically upper section of a bus bar module frame of the bus bar module, and further comprising a second hook structure disposed at a vertically lower section of the bus bar module frame, and a second foam block attached to the second hook structure.

11. A battery array for a traction battery pack, comprising:
a cell stack;
a bus bar module configured for electrically connecting a plurality of battery cells of the cell stack;
a first foam block attached to a first hook structure of the bus bar module and positioned to fill a first space between the cell stack and the bus bar module; and
a second foam block attached to a second hook structure of the bus bar module and positioned to fill a second space between the cell stack and the bus bar module.

12. The battery array as recited in claim 11, wherein the first hook structure is disposed at a vertically upper section of a bus bar module frame of the bus bar module, and the second hook structure is disposed at a vertically lower section of the bus bar module frame.

13. The battery array as recited in claim 12, wherein the first hook structure is an integral subcomponent the bus bar module frame, and the second hook structure is part of a support fixture that is clipped to the bus bar module frame.

14. The battery array as recited in claim 13, wherein the first hook structure includes a base hook and a secondary hook that protrudes outwardly from a side of the base hook.

15. The battery array as recited in claim 14, wherein the base hook includes a pair of hook legs that are at least partially separated by an indentation.

16. The battery array as recited in claim 15, wherein the secondary hook includes a design that mimics that of the base hook.

17. The battery array as recited in claim 13, wherein the first foam block is overmolded around the first hook structure.

18. The battery array as recited in claim 13, wherein the second hook structure extends from a base of the support fixture.

19. The battery array as recited in claim 13, wherein the second foam block is overmolded around the second hook structure.

20. The battery array as recited in claim 13, wherein the second hook structure includes a flexible clip that engages a clip structure of a bus bar module frame as the support fixture is moved into engagement with the bus bar module frame.
